(19) United States
(12) Patent Application Publication
(10) Pub. No.: US 2026/0093053 A1
(43) Pub. Date: Apr. 2, 2026

(54) METHOD OF LOCATING AND MAPPING A UTILITY WITH RTK GPS

(71) Applicant: The Charles Machine Works, Inc., Perry, OK (US)

(72) Inventors: Carlos Finocchiaro, Owasso, OK (US); Quinton Tetik, Perry, OK (US); Rodolfo Cabello, JR., Perry, OK (US)

(21) Appl. No.: 19/338,871

(22) Filed: Sep. 24, 2025

Related U.S. Application Data
(60) Provisional application No. 63/700,150, filed on Sep. 27, 2024.

(51) Int. Cl. G01V 3/16; G01V 3/36; G06T 11/60

(52) U.S. Cl. CPC G01V 3/16; G01V 3/36; G06T 11/60

(57) ABSTRACT

A system and method for accurately locating and logging locations of an underground utility. The system has access to a map layer which may be simultaneously displayed on a device with a point layer and/or a line layer associated with the underground utility. Information related to the map layer, line layer, and point layer may all be stored on a remote database, such as a cloud database, and accessed and edited both at a device incorporated into, or proximate, the locator, and a device at a remote location, such as a remote computer. When changes are made to data features, the display is updated in real time to show these edits.

### SUMMARY

The present invention is directed to a method of locating and mapping an underground utility line. The method comprises transmitting a signal through the underground utility line, receiving, at a utility locator comprising one or more antennas, the transmitted signal from the underground utility line and identifying a plurality of above-ground locations overlying the underground utility line.

The method further comprises transmitting a location data set representing the plurality of above-ground locations from the utility locator to a first device utilizing peer-to-peer communication, transmitting the location data set from the first device to a cloud file system through a cellular network, and transmitting the location data set from the cloud file system to the first device through the cellular network and displaying, on the first device, a map file having a graphical representation of the plurality of above-ground locations.

In another aspect the invention is directed to a method of locating and mapping an underground utility line. The method comprises transmitting a signal through the underground utility line, receiving the transmitted signal from the underground utility line at a utility locator via one or more antennas of the utility locator, receiving a geographic position of the locator at the locator, and logging a first above-ground point associated with the underground utility line.

The method further comprises transmitting the first and second above-ground points from the utility locator to the first device utilizing peer-to-peer communication and displaying a map on the first device showing the first and second above-ground points in real time. Thereafter, the first point is selected on the first device, and an icon is displayed to direct a user to the geographic position associated with the first point with a GNSS antenna in the first device.

In another aspect the invention is directed to a method of creating a real-time map of an underground utility line. The method comprises detecting, at a utility locator comprising an antenna at a first above-ground location, a signal transmitted from the underground utility line, detecting the absolute position of the first above-ground location and detecting, at the utility locator at a second above-ground location, a signal transmitted from the underground utility line.

The method further comprises transmitting a first location data set from the utility locator to a first device utilizing peer-to-peer communication, transmitting the first location data set from the first device to a cloud file system through a cellular network, and transmitting the first location data set and a map layer file from the cloud file system to the first device. The first above-ground location, the second above-ground location and the map layer are displayed simultaneously.

### BRIEF DESCRIPTION OF THE DRAWINGS

FIG. 1 is a diagrammatic representation of a locating job, with a locator, transmitter, and GNSS antenna cooperating to determine an absolute position of a buried utility.

FIG. 2 is a diagrammatic representation of a communication protocol, whereby a remote database stores and transmits logged information related to a field at which an underground line is located.

FIG. 3 is an example screen of a field map having a line layer and point layer.

FIG. 4 is a close-up view of the image of FIG. 3.

FIG. 5 is an example screen of a navigation application, whereby an operator holding a portable device is directed to a locate point.

FIG. 6 is a flow chart depicting a method of editing locate points and simultaneously updating information on a portable device at a site of line location.

### DETAILED DESCRIPTION

The current invention provides a new method of locating and mapping existing underground utilities. The utility line emits an electromagnetic field which is detected and measured by one or more antennas housed inside a utility locator, an exemplar utility locator is provided in U.S. Pat. No. 10,042,074, the contents of which are incorporated herein by reference. When paired with high accuracy global navigation satellite system (“GNSS”), it becomes possible to create a map representing a located utility line with high precision and accuracy.

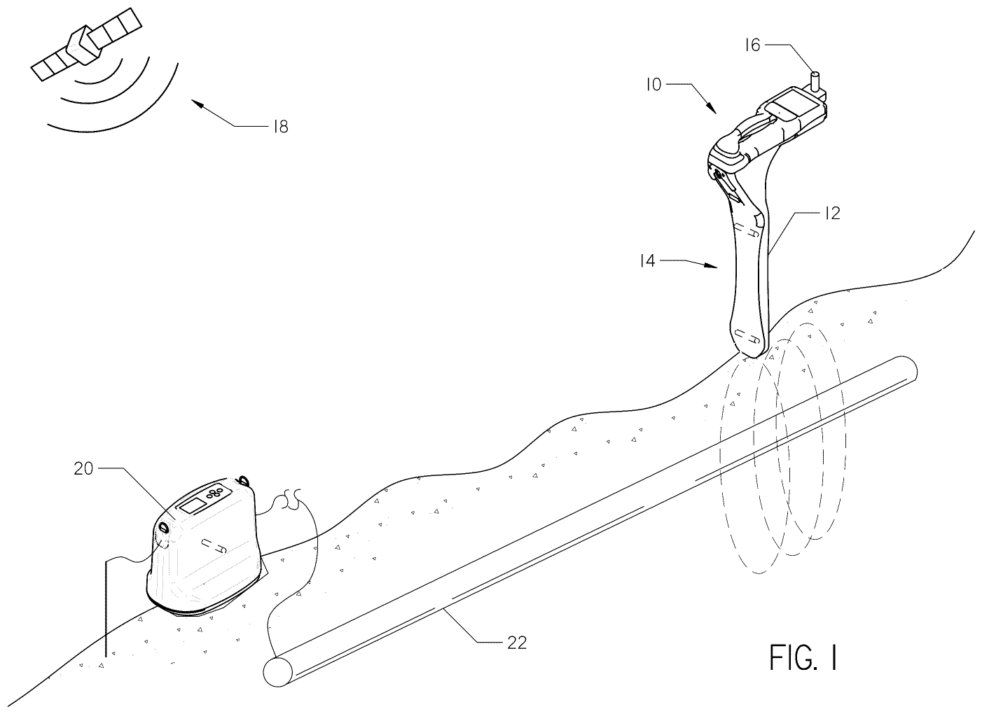

A locator 10 is shown in FIG. 1. The locator 10 comprises a frame 12, an antenna array 14, and a GNSS antenna 16. The antenna array 14 typically comprises multiple antenna loops or coil-wrapped ferrite rods, and is configured to detect a signal emanating from an underground region, such as a signal placed on a utility line for detection.

The frame 12 is oriented such that the antenna array 14 is close to a surface of the ground when held by an operator. The antenna array 14 may be a plurality of coil-wound ferrite rods of the type commonly used in such locators 10.

The GNSS antenna 16 is configured to communicate with one or more satellites 18. Preferably, the GNSS antenna 16 is a real-time kinematic (“RTK”) antenna capable of accuracy of 15 millimeters or less.

A transmitter 20 energizes an underground line 22 in locating operations. The transmitter 20 may place a signal on the line 22 to be detected through either a direct connection or induction. This signal illuminates the line 22 such that the locator 10 can detect the position and depth of the line 22 by detecting the emitted signal using the antenna array 14. Thus, in the system described, as in existing art, the locator 10 may plot points and depth along a path overlying a below-ground line 22 and, using the GNSS antenna 16, record an absolute location of such points.

The locator 10 thus has the ability to locate and log georeferenced points that correspond with the location of an underground utility line. Each point recorded may comprise metadata related to the locate point. For example, each point may include information related to the frequency, signal strength, depth, GPS accuracy, utility type, or any number of other parameters associated with a locate parameter or the located utility line 22.

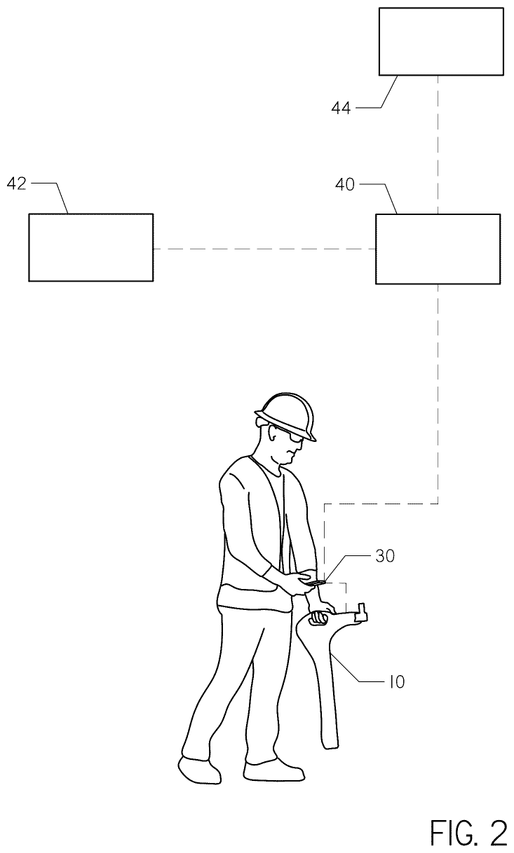

With reference to FIG. 2, the utility locator 10 may be wirelessly paired with a portable device 30 such as a smartphone or tablet with cellular or satellite connectivity. In the prior art, data packets comprising the locate points and corresponding meta data would be transferred from the locator 10 to the portable device 30 for viewing on a mapping system stored on the portable device 30 or at a remote database 40. This process is often performed manually in batch uploads.

In the present invention, the portable device 30 communicates directly with the utility locator 10 and with the remote database 40. The remote database 40 may be a cloud file system, or may be a remote server, or other data storage medium. A field application may be used on the locator 10 or the portable device 30, and comprises a user interface for organizing and viewing created field maps. A user may create and store multiple field maps. The maps preferably include a Geographic Information System (“GIS”) map, such as an “Esri” layer. Such map layers may be transmitted from a map server 44. The user may choose to create a new field map for each locate job, or each field map may comprise locate points from multiple job sites.

Each field map may be shown simultaneously. For example, a base map may be made of multiple feature, raster, or web layers. Preferably, the base map will comprise satellite imagery.

For example, there may be a point sub-layer, which may be created within the GIS ecosystem prior to being utilized within the current application. The point sub-layer may or may not contain point data prior to integration into a new field map.

Additionally, there may be a line sub-layer. The line sub-layer references a line feature layer, which may also be created within the GIS ecosystem prior to being utilized within a field map. As will be discussed in more detail below, the line layer may be automatically edited in response to at least two points being added to the point layer.

By embedding an API key for a map layer in the field application, a user can access a map server 44 to securely connect to GIS services, track usage, and manage access to specific capabilities.

Utility locators 10 are intended to be used with a RTK correction service. The field application on the portable device 30 provides an interface in which to choose and connect to the desired RTK positioning correction service. While in the Figures, the locator 10 comprises the onboard RTK enabled GNSS antenna 16, an alternative embodiment may include a GNSS antenna housed in the portable device 30 or in a separate unit.

Once a new field map is created and selected within the field application, locate points may be collected from the locator 10 and associated with the selected field map. Points are typically collected by pressing a button on the locator 10. Alternatively, locate points may be collected through any other available user input means, such as voice control. Once a data point is recorded, each point and its corresponding data is transmitted in real time from the locator 10 to the remote database 40 in which the point and line layers are stored. The point layer is automatically updated with the new locate point in the remote database 40. Such updates are referred to herein as field edits.

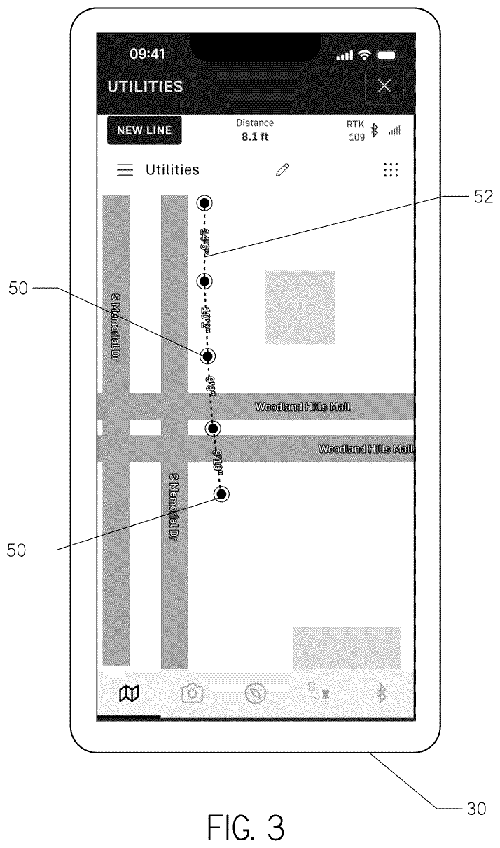

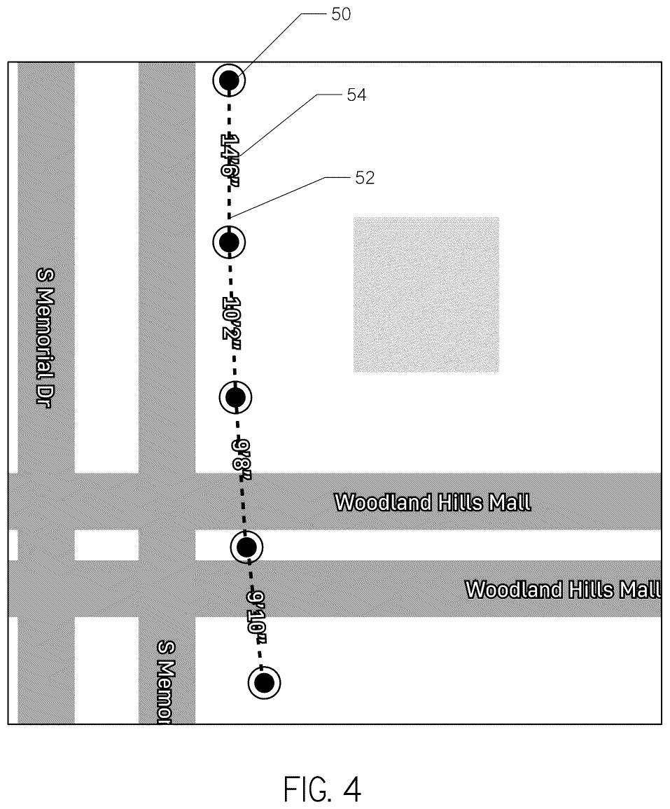

Any device with viewing access to the point layer may then be automatically updated to see the field edit. As a result, when viewing the field map within the application, as shown in FIGS. 3-4, a new locate point 50 will automatically update the view on the portable device 30 to show the added locate point. Once at least two points have been collected and recorded, a processor on the portable device 30 may automatically calculate a line 52 between the two points 50. Alternatively, a new line 52 can be created by manually inputting or accessing line data. This will end the current line at the previous data point, and a new line will begin with the next two data points 50. Once the processor calculates the position and length of the line in relation to the two points a signal is transmitted from the portable device 30 to the remote database 40 to edit the line layer. Once the line layer edit is made within the database 40 the line layer edits are then automatically transmitted back to the portable device 30 where they are viewable on the field map view. As can be seen in the close-up view in FIG. 4, the measured distance 54 between the points is automatically calculated and displayed in the map view within the field application.

While the figures show the field map view within the field application, the edited point 50 and line 52 layers may be simultaneously viewed from any device with access to the point and line layers. For example, a user may remotely view field edits to the point and line layers at a remote computer 42 with access to the requisite map layers from the map server 44. Additionally, the remote user may not only view, but edit point 50 and line 52 features while the locate technician on site continues to make new field edits. These point and line edits-referred to as office edits-by the remote user would also be viewable in the field map in real time at the portable device 30.

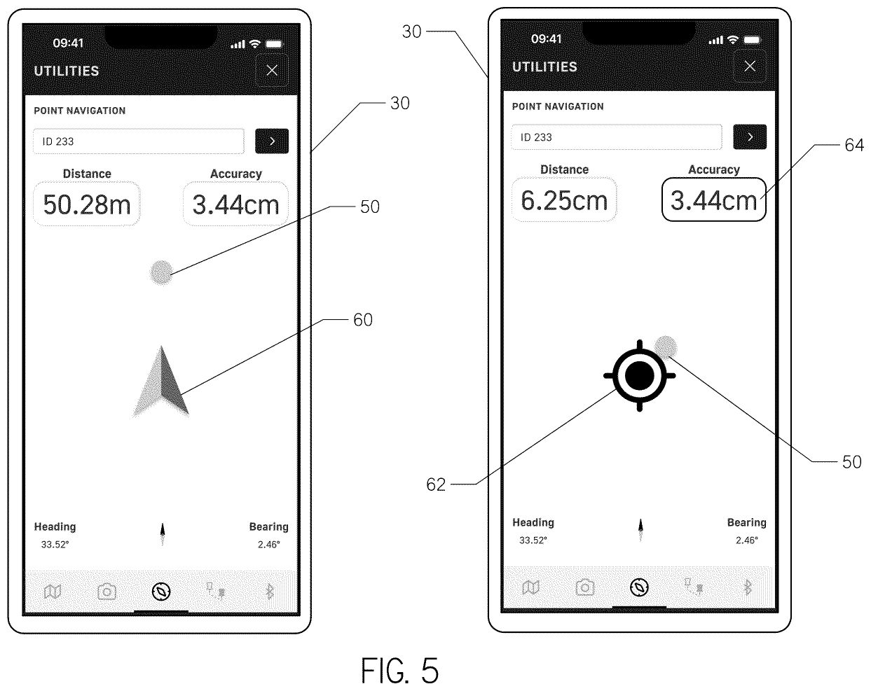

As shown in FIG. 5, the field application allows the locate technician or other field application user onsite to navigate to a previously located log point. Each point 50 shown in a field map has an associated point ID. The user may enter a point ID into the point navigator in order to navigate to the selected point 50. The point navigator may be used within the point navigation with or without the locator 10. If the locator 10 is paired to the portable device 30, the point navigation may utilize the RTK GNSS antenna 16 on the utility locator 10. If the locator is not paired to the portable device, the portable device 30 may utilize its own native GNSS antenna.

Any point 50 referenced within a point layer, that is part of a field map, may be entered into the point navigator. Therefore, the point navigator may navigate to a point that was entered from either a field edit or an office edit.

The point navigator will guide the user to the selected point 50. Preferably, as shown in FIG. 5, the user interface may provide an arrow icon 60 on the display screen of the portable device 30 to direct the user until the user is within a predetermined distance to the selected point. Once the user is within the predetermined distance, for example, less than 10 cm, the arrow icon 60 will change to a target icon 62.

The accuracy of the GNSS signal received may be indicated on the display during point navigation. The accuracy 64 of the GNSS signal received in FIG. 5 is shown in the top right of the display screen of the portable device 30. Color, or other visual indicators may also be used to identify the accuracy of the GNSS during point navigation. For example, green, amber, and red may be used. Other color indications may be utilized, or color/pattern combinations may be utilized.

The portable device 30 discussed is primarily in the context of a smart device such as a smartphone or tablet. However, the field application may also be implemented in an augmented reality environment, such as made possible by an augmented reality headset or on a portable device with a rear-facing camera.

In operation, the system discussed enables the performance of steps which together form a method of collecting and communicating data generated from a locating operation.

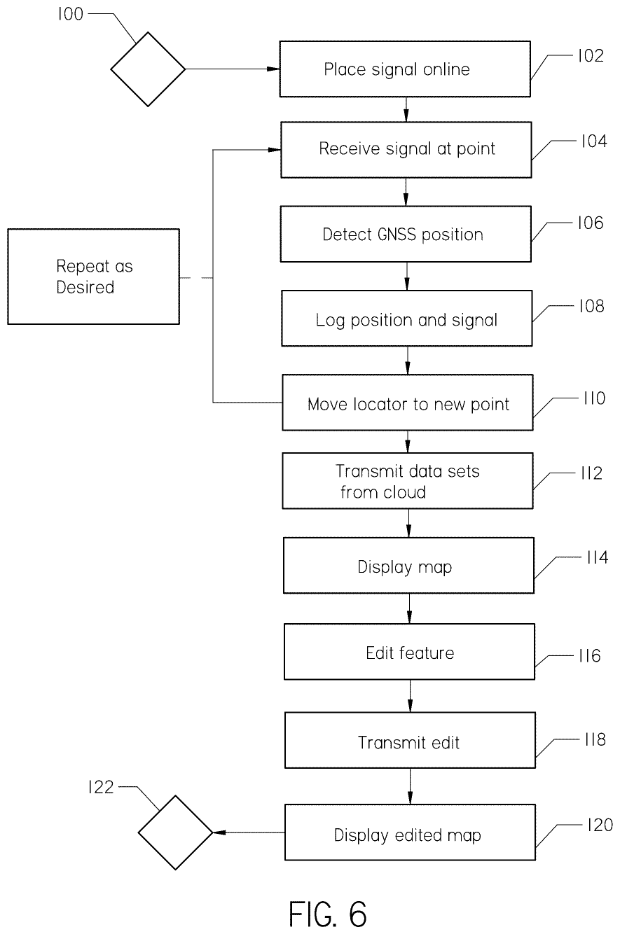

With reference to FIG. 6, one such method is shown. At step 100, the method begins. At step 102, the transmitter 20 places a signal on an underground utility line 22. At step 104, the above-ground locator 10 is used to receive the transmitted signal at an above-ground location. The absolute position of the above-ground location is then detected at step 106 using the GNSS antenna 16. Thus, the first above-ground point 50, as detected, can be logged at step 108.

At step 110, the above-ground locator 10 may be moved to a second point 50, and steps 104 and 106 repeated, with the information logged again at step 108. It should be understood that ‘logging’ information at step 108 may comprise transmitting the information to the portable device 30 using peer-to-peer communication such as Bluetooth™. In addition, it may include transmission of the information from the portable device 30 to the remote database 40, such as a cloud file system.

The data sets, such as field maps, may be transmitted from the cloud at step 112, both to a remote computer 42 and the portable device 30. A map showing the plurality of locations at which the signal was received and position was detected (at steps 104 and 106, respectively) may be displayed at step 114. An edit to one or more of the features of the displayed map may be made by an operator at step 116. This edit may take place at a remote computer 42. The edited map is transmitted to the remote database 40 at step 118, and the edited map is then transmitted from the remote database 40 to both the remote computer 42 and the portable device 30 at step 120.

Preferably, when the map is updated at step 116, the steps of transmitting the edits at 118 and 120 occur in real time, such that an operator, in possession of a locator 10 and the portable device 30, may immediately appreciate the edits.

Further, the signal received at step 104 may be utilized to direct an operator to move the locator 10 to a position above the underground line, prior to detecting GNSS position at step 106 and logging the signal attributes at that point at step 108.

The line layer may be superimposed upon the map layer, and upon edits to the locate points 50 at step 116, other layers using such data, such as the line layer, may be edited to adjust to the updated locate points. Once a utility is fully mapped, and any needed corrections incorporated, the method ends at step 122.

The various features and alternative details of construction of the apparatuses described herein for the practice of the present technology will readily occur to the skilled artisan in view of the foregoing discussion, and it is to be understood that even though numerous characteristics and advantages of various embodiments of the present technology have been set forth in the foregoing description, together with details of the structure and function of various embodiments of the technology, this detailed description is illustrative only, and changes may be made in detail, especially in matters of structure and arrangements of parts within the principles of the present technology to the full extent indicated by the broad general meaning of the terms in which the appended claims are expressed.

1. A method of locating and mapping an underground utility line, the method comprising:
transmitting a signal through the underground utility line;
receiving, at a utility locator comprising one or more antennas, the transmitted signal from the underground utility line;
identifying a plurality of above-ground locations overlying the underground utility line;
transmitting a location data set representing the plurality of above-ground locations from the utility locator to a first device utilizing peer-to-peer communication;
transmitting the location data set from the first device to a cloud file system through a cellular network; and
transmitting the location data set from the cloud file system to the first device through the cellular network and displaying, on the first device, a map file having a graphical representation of the plurality of above-ground locations.

2. The method of claim 1, further comprising:
simultaneously with the step of transmitting the location data set from the cloud file system to the first device, transmitting the location data set from the cloud file system to a remote computing device; and
displaying, on the remote computing device, a map showing the plurality of above-ground locations.

3. The method of claim 2, further comprising:
editing one of the plurality of above-ground locations at the remote computing device; and
updating, in real time, the edited above-ground location in the cloud file system.

4. The method of claim 3, further comprising:
transmitting the edited above-ground location from the cloud file system to the first device in real time; and
displaying the edited above-ground location on the map on the first device.

5. A method of locating and mapping an underground utility line, the method comprising:
transmitting a signal through the underground utility line;
receiving, at a utility locator, the transmitted signal from the underground utility line via one or more antennas of the utility locator;
receiving, at the utility locator, a geographic position of the locator, and logging a first above-ground point associated with the underground utility line;
moving the utility locator and logging a second above-ground point associated with the underground utility line;
transmitting the first and second above-ground points from the utility locator to a first device utilizing peer-to-peer communication;
displaying, on the first device, a map showing the first and second above-ground points in real time;
thereafter, selecting the first point on the first device and displaying an icon to direct a user to the geographic position associated with the first point with a GNSS antenna in the first device.

6. The method of claim 5, further comprising:
moving the utility locator and logging a third above-ground point associated with the underground utility line.

7. The method of claim 6, further comprising updating the map with the third above-ground point in real time.

8. The method of claim 5, further comprising:
before the step of logging the first above-ground point, using the received signal to direct the utility locator to a position directly above the underground utility line; and
moving the locator to a position directly above the underground utility line.

9. The method of claim 8, further comprising logging the first above-ground point after verifying the locator is at the position directly above the utility line.

10. A method of creating a real-time map of an underground utility line, comprising:
detecting, at a utility locator comprising an antenna at a first above-ground location, a signal transmitted from the underground utility line;
detecting the absolute position of the first above-ground location;
detecting, at the utility locator at a second above-ground location, a signal transmitted from the underground utility line;
detecting the absolute position of the second above-ground location;
transmitting a first location data set from the utility locator to a first device utilizing peer-to-peer communication;
transmitting the first location data set from the first device to a cloud file system through a cellular network; and
transmitting the first location data set and a map layer file from the cloud file system to the first device; and
displaying the first above-ground location, the second above-ground location and the map layer simultaneously.

11. The method of claim 10, further comprising:
transmitting the first location data set and the map layer file to a second device; and
displaying the first above-ground location, the second above-ground location, and the map layer on the second device.

12. The method of claim 10, further comprising:
from a second device, accessing the cloud file system; and
from the second device, editing the first location data set.

13. The method of claim 12, further comprising:
thereafter, displaying the edited location data set and the map layer simultaneously at the device.

14. The method of claim 12, further comprising:
simultaneously with the step of editing the first location data set, updating the displayed first above-ground location or the second above-ground location.

15. The method of claim 10, in which the first location data set is placed into a line layer, in which the first above-ground location and the second above-ground location are displayed in the line layer, wherein the line layer is superimposed on the first device above the map layer.

16. The method of claim 10, in which the first device comprises a smartphone.

17. The method of claim 16, in which the first above-ground location and second above-ground location are detected with a GNSS antenna in the smartphone.

18. The method of claim 10, in which the first above-ground location and the second above-ground location are directly above the underground utility line.

19. The method of claim 18, further comprising:
generating a line layer from the first location data set; and
superimposing the line layer onto the map layer on the first device.
